(19) United States
(12) Patent Application Publication
(10) Pub. No.: US 2006/0095517 A1
(43) Pub. Date: May 4, 2006

(54) Wide area wireless messaging system

(76) Inventors: Clint H. O'Connor, Austin, TX (US); Douglas M. Anson, Dripping Springs, TX (US)

Correspondence Address: HAMILTON & TERRILE, LLP, P.O. BOX 203518, AUSTIN, TX, 78720, US

(21) Appl. No.: 10/963,126

(22) Filed: Oct. 12, 2004

(51) Int. Cl. G06F 15/16

(52) U.S. Cl. 709/206

(57) ABSTRACT

A method and apparatus for improved handling of messages transmitted over a plurality of wireless and wired networks. Electronic mail transmitted by a mail source via an internet connection is received by a server that is operably connected to an intranet that is protected by a firewall. The server adds a timestamp to the incoming email and forwards the email to first information handling system. The server also relays the email to a network operations center (NOC) that transmits a copy of the email via a wireless transmitter. The present invention provides a method and apparatus to selectively prevent transmission of the relayed email by the NOC by sending a cancellation signal to the NOC or by suppressing the relay of the email to the NOC, thereby providing a cost saving and increased efficiency of bandwidth utilization.

### BACKGROUND OF THE INVENTION

1. Field of the Invention

The present invention relates in general to the field of information handling systems and, more specifically, to messaging networks used by information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

In recent years there has been a significant increase in the use of wireless wide area networks (WWAN) for messaging and other data communication. WWAN messaging devices such as Goodlink G100, RIM Blackberry, and Pocket PC Phone, enable users to travel and receive/send email and other personal information over broad areas using GPRS or CDMA carriers. The providers supporting these devices (e.g., Good) operate a Network Operations Center (NOC) that controls all traffic to these devices. These providers typically control the messaging traffic and charge for the traffic through the NOC. An organization generally links its mail server (using Microsoft® Exchange®, for example) to the NOC. The user is charged on a monthly basis for messaging. Incoming mail is usually received at the organization's mail server from internal sources or other Internet-based mail servers, including STMP, etc., and is sent to the NOC. The NOC schedules the message for transmission over WWAN carriers at the user's location. There is no provision among these services for devices that connect directly by docking or WLAN wireless means to the user's PC which is also connected to the organization's mail server. This would be desirable for reasons of efficiency and security, since there would not be a need to go outside the organization's firewall.

### SUMMARY OF THE INVENTION

The method and apparatus of the present invention provides improved handling of messages transmitted over a plurality of wireless and wired networks. In the present invention, electronic mail transmitted by a mail source via an internet connection is received by a server that is operably connected to an intranet that is protected by a firewall. The server adds a timestamp to the incoming email and forwards the email to an information handling system (sometimes referred to as a “personal computer” or “PC”). The server also relays the email to a network operations center (NOC) that transmits a copy of the email via a wireless transmitter. The wirelessly transmitted copy of the email can be received by an authorized user via a portable information handling system (sometimes referred to as a “portable personal computer” or “PPC”) that comprises a wireless transceiver. The PPC and the PC can be connected to the network by a wired connection or via a wireless local area network (WLAN). In one embodiment of the invention, PPC is connected to the network by establishing a wired or wireless connection to the PC. In this embodiment, the PPC is operable to synchronize email and data files with the PC. In another embodiment of the invention, the PPC is connected directly to the server via a wired connection or a wireless local area network connection. In this embodiment, the PPC is operable to synchronize email and data files directly with the server.

The present invention provides a method and apparatus to selectively prevent transmission of the relayed email by the NOC by sending a cancellation signal to the NOC or by suppressing the relay of the email to the NOC. In one embodiment of the invention, a cancellation signal is sent to the NOC when the PPC is connected to, and synchronized with, the PC. In this embodiment of the invention, the NOC can enhance bandwidth utilization by adding a time delay between receiving a message and transmitting it to the carrier. In yet another embodiment of the invention, the “relay copy” of the email is stored in a FIFO queue for a delay period. If the PPC is detected during the time delay period, then the email is not relayed to the NOC for transmission. As will be understood by those of skill in the art, the method and apparatus of the present invention provides numerous advantages, including bandwidth savings for the wireless carrier and costs savings for the user.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is an illustration of a messaging system for transmitting messages over a plurality of wireless and wired networks.

FIG. 2 is a block diagram of an information handling system in accordance with the present invention.

FIG. 3 is an illustration of one embodiment of a messaging system for transmitting messages over a plurality of wireless and wired networks in accordance with the present invention.

FIG. 4 is an illustration of an alternate embodiment of a messaging system for transmitting messages over a plurality of wireless and wired networks in accordance with the present invention.

### DETAILED DESCRIPTION

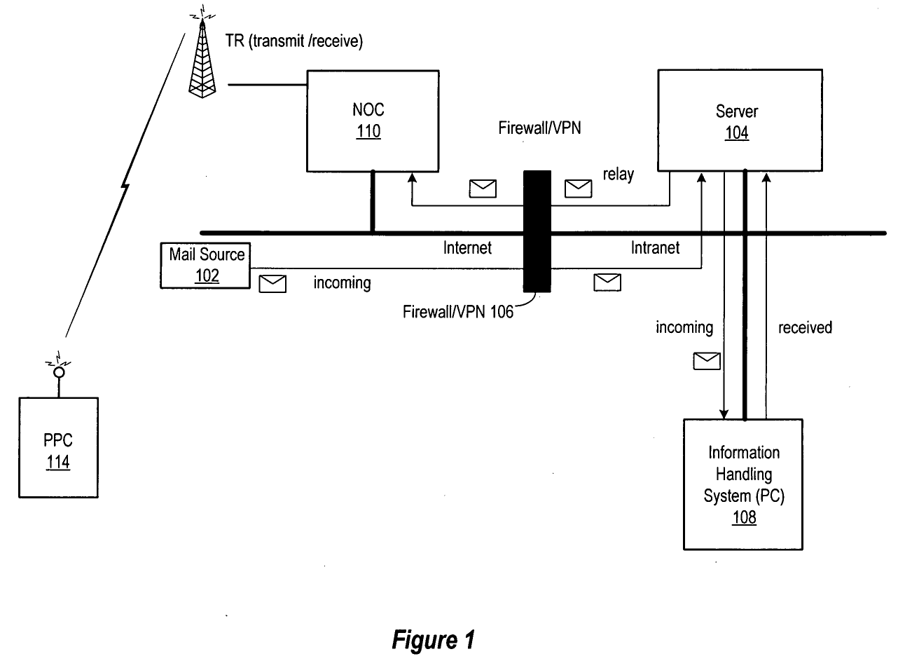

FIG. 1 is an illustration of a messaging system for transmitting messages over a plurality of wireless and wired networks. Electronic mail transmitted by a mail source 102 via an internet connection is received by a server 104 that is operably connected to an intranet that is protected by a firewall 106. The server 104 adds a timestamp to the incoming email and forwards the email to the information handling system 108 (sometimes referred to hereinbelow as a “personal computer” or “PC”). The server also relays the email to a network operations center (NOC) 110 that forwards a copy of the email to a carrier that transmits the email via a wireless transmitter 112. The wirelessly transmitted copy of the email can be received by an authorized user via a portable information handling system 114 (sometimes referred to hereinbelow as a “portable personal computer” or “PPC”) that comprises a wireless transceiver.

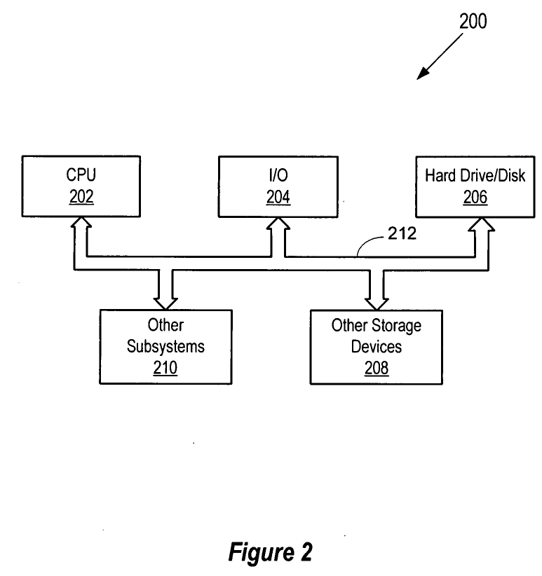

FIG. 2 is a generalized illustration of an information handling system 200. The functional components of the information handling system 200 can be implemented in the various information handling systems illustrated in FIG. 1, including the server, personal computer and handheld computer. The information handling system includes a processor 202, input/output (I/O) devices 204, such as a display, a keyboard, a mouse, and associated controllers, a memory drive 206, and other storage devices 208, that may include a floppy disk and drive and other memory devices, and various other subsystems 210, all interconnected via one or more buses 212. The software that is installed according to the versioning methodology is installed onto hard disk drive 206. Alternately, the software may be installed onto any appropriate non-volatile memory.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

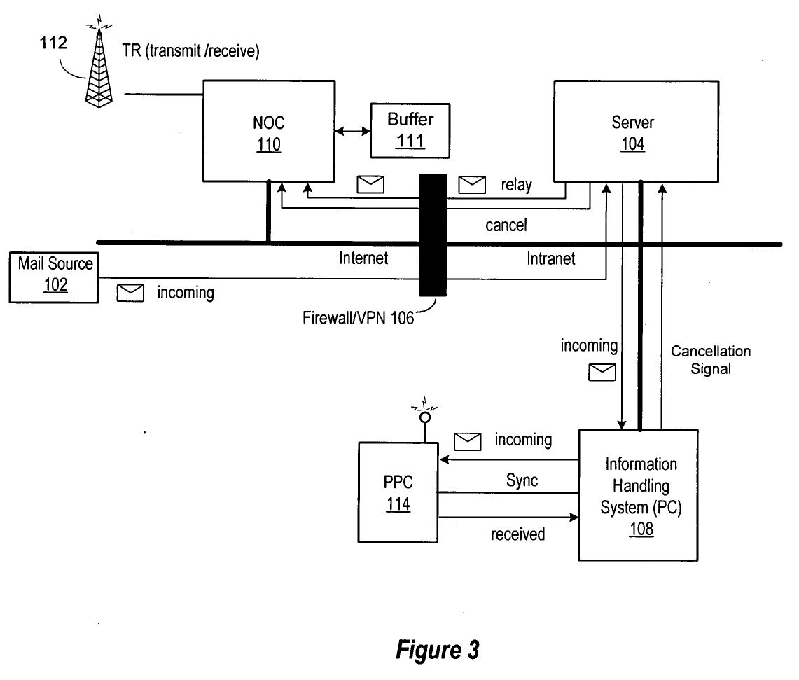

FIG. 3 is an illustration of one embodiment of the wide area network wireless messaging system that is implemented in accordance with the present invention. Electronic mail transmitted by the mail source 102 via an internet connection is received by the server 104 that is operably connected to an intranet that is protected by a firewall 106. The server 104 adds a timestamp to the incoming email and forwards the email to the information handling system 108. The server is also operable to relay the email to a network operations center (NOC) 110 that transmits a copy of the email via a wireless transmitter 112 for transmission to a wirelessly enabled PPC 114. In the embodiment illustrated in FIG. 3, however, the PPC 114 is also connected (via wire, WPAN, or WLAN) to the user's PC 108, which is connected to the organization's mail server. It is also understood that the device can connect directly with a mail server, given the appropriate protocol handling (e.g., an MIS server).

In the embodiment illustrated in FIG. 3, the arrival of the message at the PC 108 automatically triggers a synchronization of the PC 108 and the PPC 1 14. The message is received at the PPC 114 and receipt is confirmed at the PC 108. The PC 108 sends a short cancellation message to the server 104. The server 104 then sends a cancellation notice to the NOC 110 containing the information regarding the message to be cancelled. At this point there are several possibilities regarding the status of the previously relayed message: (1) the message has already been sent by the NOC 110 and carrier (dismiss the cancellation), (2) the message is in transmission or has been sent by the NOC 110 to the carrier but not transmitted over the air yet (the cancellation is forwarded to the carrier which terminates the transmission), or (3) the message is queued at the NOC (the NOC cancels the message and does not charge the customer—bandwidth has been freed for other customers). As will be understood by those of skill in the art, the bandwidth savings related to the procedures described hereinabove can be enhanced if the NOC stores the message in a buffer and adds a small time delay between receiving a message and transmitting it to the carrier.

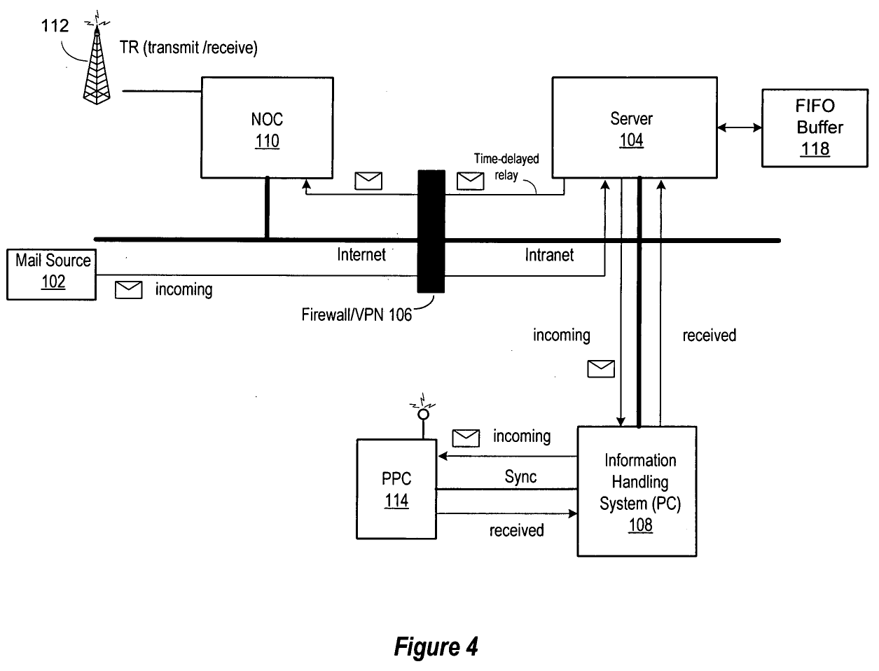

FIG. 4 is an illustration of an alternate embodiment of the present invention wherein the cancellation signal generated by the PC 108 is used by the server 104 to prevent the relaying of the message to the NOC 1 10. The embodiment of the invention illustrated in FIG. 4 is particularly useful for situations where the NOC 110 does not wish to participate in the cancellation procedure. In this embodiment, an outgoing FIFO buffer 118 with a delay period is added. Messages are queued in the FIFO 118 for a short interval to allow time for the PPC 114 to synchronize with the PC 198 and receive the messages. If a cancellation is not received within the delay period, the message is allowed to proceed to the NOC 110.

The embodiment illustrated in FIG. 4 can also be used for messages originating at the PC 108 or the PPC 114 (either connected to the PC 108 or independently). In this case the PPC 114 or the PC 108 timestamps the outgoing message. If the synchronizing PC 108 is present, the message is sent to the PC 108 and reception is confirmed, thereby reaching the server 104 directly. In this case, the message is not sent to the NOC 110. If the synchronization fails and retries are unsuccessful or the PC 108 is not attached, then the message is sent over a WWAN carrier to the NOC 110. This reduces operating expenses for the organization without requiring the NOC 110 provider's participation.

The various embodiments of the invention illustrated in FIG. 3 and FIG. 4 can be implemented with wired network connections or via wireless LAN access through access points to allow the PPC 114 and the PC 108 to communicate wirelessly with the server 104. In one embodiment of the invention, PPC is connected to the network by establishing a wired or wireless connection to the PC. In this embodiment, the PPC is operable to synchronize email and data files with the PC. In another embodiment of the invention, the PPC is connected directly to the server via a wired connection or a wireless local area network connection. In this embodiment, the PPC is operable to synchronize email and data files directly with the server. In the embodiment of the invention where the PPC is directly connected to the server, the email message is sent directly to the PPC 114 and is not sent to the PC 108. If the PPC is not within range of the server's wireless LAN and is not connected to the server by a wired network connection, the email message is relayed to the NOC 110.

In the embodiments wherein the PC or the PPC are wirelessly connected to the network, the delay time for relaying the email messages must be adjusted to allow for the timing of communications through the wireless LAN, since synchronization over wireless takes more time than a wired connection. Connection status messaging between the PPC 114 and the server 104 or NOC 110 can be employed to adjust this delay based on the speed of the connection.

Although the present invention has been described in detail, it should be understood that various changes, substitutions and alterations can be made hereto without departing from the spirit and scope of the invention as defined by the appended claims.

What is claimed is:

1. A system for communicating messages over a network, comprising:
A first information handling system operably connected to an network, said first information system operable to receive a message and to relay a copy of said message;
a second information handling system operably connected to said network; and
a third information handling system operably connected to said second information handling system;
wherein said first information handling system is operable to:
relay a copy of the message to a network operations center;
transfer a copy of the message to said second information handling system; and
transmit a cancellation notice to said network operations center upon detection of said third information handling system being connected to said second information handling system, thereby causing said network operation center to cancel retransmission of said message to said third information handling system.

2. The system of claim 1, wherein said first information handling system comprises a server.

3. The system of claim 1, wherein said second information handling system comprises a personal computer.

4. The system of claim 1, wherein said third information handling system comprises a wirelessly enabled portable information handling system.

5. The system of claim 1, wherein said message is originated by a mail source connected to the internet and is transmitted to the network via a firewall.

6. The system of claim 4, wherein said third information handling system is detected during a synchronization operation.

7. The system of claim 6, wherein said message is stored by the network operations center for a predetermined time prior to wireless transmission of said message.

8. A method for communicating over a network, comprising:
receiving a message in a first information handling system operably connected to an network;
relaying a copy of the message to a network operations center;
transferring the message to a second information handling system operably connected to the network;
detecting whether a third information handling system is operably connected to said second information handling system;
generating a cancellation signal upon detection of the third information handling system; and
using the cancellation signal to prevent transmission of the message by the network operations center.

9. The method of claim 8, wherein said first information handling system comprises a server.

10. The method of claim 8, wherein said second information handling system comprises a personal computer.

11. The method of claim 8, wherein said third information handling system comprises a wirelessly enabled portable information handling system.

12. The method of claim 8, wherein said message is originated by a mail source connected to the internet and is transmitted to the network via a firewall.

13. The server of claim 11, wherein said third information handling system is detected during a synchronization operation.

14. The server of claim 13, wherein said message is stored by the network operations center for a predetermined time prior to wireless transmission of said message.

15. A system for communicating messages over a network, comprising:
a first information handling system operably connected to an network, said first information system operable to receive a message and to relay of copy of said message;
a second information handling system operably connected to said network; and
a third information handling system operably connected to said second information handling system;
wherein said first information handling system is operable to:
store said message in a buffer for a predetermined period of time;
transfer a copy of the message to said second information handling system to said third information handling system; and
relay a copy of the message to a network operations center if the server has not received a cancellation signal during said predetermined period of time.

16. The system of claim 1, wherein said first information handling system comprises a server.

17. The system of claim 1, wherein said second information handling system comprises a personal computer.

18. The system of claim 1, wherein said third information handling system comprises a wirelessly enabled portable information handling system.

19. The system of claim 1, wherein said message is originated by a mail source connected to the internet and is transmitted to the network via a firewall.

20. The system of claim 4, wherein said third information handling system is detected during a synchronization operation.

21. A system for communicating messages over a network, comprising:
a first information handling system operably connected to a network, said first information system operable to receive a message and to relay a copy of said message;
a second information handling system operable to connect to said network;
wherein said first information handling system is operable to:
relay a copy of the message to a network operations center;
transfer a copy of the message to said second information handling system; and
transmit a cancellation notice to said network operations center upon detection of said second information handling system being connected to said first information handling system, thereby causing said network operation center to cancel retransmission of said message to said second information handling system.

22. The system of claim 21, wherein said first information handling system comprises a server.

23. The system of claim 21, wherein said second information handling system comprises a wirelessly enabled portable information handling system.

24. The system of claim 21, wherein said message is originated by a mail source connected to the internet and is transmitted to the network via a firewall.

25. The system of claim 21, wherein said second information handling system is detected during a synchronization operation.

26. The system of claim 21, wherein said message is stored by the network operations center for a predetermined time prior to wireless transmission of said message.
